(19) United States
(12) Patent Application Publication
(10) Pub. No.: US 2015/0367440 A1
(43) Pub. Date: Dec. 24, 2015

(54) METHOD AND DEVICE FOR ROLL SEAM WELDING CONTAINER FRAMES

(71) Applicant: SOUDRONIC AG, Bergdietikon (CH)

(72) Inventors: Daniel Dieterich, Hittnau (CH); Willi Muller, Oberwil-Lieli (CH)

(21) Appl. No.: 14/440,743

(22) PCT Filed: Oct. 25, 2013
(86) PCT No.: PCT/CH2013/000183

§ 371 Date: May 5, 2015

(30) Foreign Application Priority Data
Nov. 6, 2012 (CH) 2260/12

(51) Int. Cl. B23K 11/06; B23K 11/30; B23K 11/25; B23K 11/16

(52) U.S. Cl. CPC B23K 11/061; B23K 11/163; B23K 11/3036; B23K 11/25

(57) ABSTRACT

The invention relates to the roll seam welding of container frames wherein a first welding procedure is carried out using welding rolls (10, 11) and subsequently the welded frame is fed to a second welding procedure using welding rolls (20, 21). The welding force of the second welding procedure is adjusted in accordance with a welding parameter for welding quality that has been determined during the first welding procedure. In this manner even sheet metals that are difficult to weld can be welded with better welding quality and the welding quality can be improved.

### CROSS REFERENCES TO RELATED APPLICATIONS

This application claims the priority of Swiss patent application No. 2260/12, filed Nov. 6, 2012, the disclosure of which is incorporated herein by reference in its entirety. The application is also a nationalization of PCT Application Number PCT/CH2013/000183 which is incorporated herein by reference in its entirety.

### FIELD OF THE INVENTION

The invention relates to a method for roll seam welding the overlapping or butting edges of a sequence of container body blanks, whereby a sequence of container bodies is formed, wherein during the welding operation of a container body blank at least one welding parameter that is relevant for the weld quality is detected and evaluated. The invention further relates to a roll seam welding device comprising weld rolls, a transport unit and a calibration unit for feeding container body blanks having overlapping or butting edges to the weld rolls of the device, and comprising a control unit, which is designed to detect and evaluate at least one welding parameter that is relevant for the quality of the generated weld seam during the welding operation of a container body.

### BACKGROUND

It is known to weld the longitudinal seams of previously rounded container body blanks, in particular can body blanks, by way of roll seam welding. The weld seams of containers, and in particular of cans for foods or for aerosols, must satisfy high quality requirements. In addition to being liquid- and air-tight, the weld seam must also be suited for flawless coating with a coating material for inside coating and outside coating of the containers. Instead of tin-plated sheet steel (tinplate), which is known to be used for the containers, the use of electrolytically chromium-coated steel (ECCS) may be desired in the packaging industry, which poses higher demands on the welding process. In addition, it is aspired to further increase the welding speed. So as to improve the weld quality, EP-A 2 243 584 proposes to detect at least one disturbance variable during welding and to vary a mechanical or electrical controlled variable during welding, in order to reduce the influence of the disturbance variable.

### SUMMARY OF THE INVENTION

It is the object of the present invention to improve the weld quality when roll seam welding container bodies. This is intended to allow the use of metal sheets that are difficult to weld and/or to increase the welding speed.

This object is achieved in that in at least one container body of a sequence of container bodies the previously generated weld seam is subjected to a second roll seam welding operation, wherein the welding force of the second welding operation is set as a function of the at least one detected welding parameter value.

It has been found that longitudinal seams of containers can be generated in very good quality even at high welding speeds by the second welding operation using a welding force that is based on a parameter detected during the first welding operation of the weld seam of the container body, wherein in this way in particular also non-tinned sheets, and for example ECCS sheets, can be welded with a high quality of the weld seam.

The two welding operations are preferably carried out one directly after the other in the same pass of the container blank and container body through a welding machine. As an alternative, a second welding machine may be connected downstream of the first welding machine. Then the container body welded by the first welding machine is preferably taken by a transport means and transported by this transport means to the second welding rollers. Proceeding like this allows to work according to the method with two welding machines being separated from each other.

Preferably the weld seam temperature during or after the first welding operation is detected as the welding parameter. This can be easily provided by known weld monitoring devices. In the alternative or additionally the energy value given by the voltage drop between the first welding rolls and by the welding current will be detected as the welding parameter. If both welding parameters are detected it is preferred that the welding force of the second welding rolls is set depending on both welding parameters. Preferably Electrolytically Chromium Coated Steel (ECCS) blanks are welded.

The welding force of the second welding step will be set depending on the detected welding parameter as being lower than for the first welding step or equal to the first welding step or higher than for the first welding step, respectively. It is further preferred the setting of the second welding force depending on the detected welding parameter is set by welding a sequence of test bodies which are welded by the first and second welding and which are then examined visually and mechanically for their weld seam quality.

It is a further object of the invention to create an improved roll seam welding device.

This object is achieved by the aforementioned roll seam welding device in that the roll seam welding device comprises a second set of weld rolls, which follows the first weld rolls in the direction of the container body transport, and the control unit is designed to set the welding force of the second set of weld rolls for a container body as a function of the detected welding parameter.

It has been found that longitudinal seams of containers can be generated in very high quality, even at high welding speeds and with special types of metal sheets, by the second set of weld rolls, which allows a second welding operation using a welding force that is based on a parameter detected during the first welding operation of the weld seam of the container body blank.

Preferably the roll seam welding device is provided such that a container body welded by the first set of welding rolls can be taken in by the second set of welding rolls when the container body exits the first set. In the alternative a transport device can be provided for taking the container body welded by the first set of weld rolls and transporting the container body to the second set of weld rolls.

Preferably the roll seam welding device is arranged such that it detects the weld seam temperature during the first welding operation as the welding parameter. In the alternative the seam welding device can be adapted to detect the energy value resulting from the voltage drop between the first welding rolls and from the welding current as the welding parameter.

In a further embodiment the roll seam welding device can be adapted to detect two welding parameters wherein as a first welding parameter the weld seam temperature is detectable and as second welding parameter the energy value resulting from the voltage drop between the first welding rolls and from the welding current is detectable and wherein by the roll seam welding device the welding force of the second welding rolls is settable depending on both welding parameters.

### BRIEF DESCRIPTION OF THE DRAWING

Further embodiments, advantages and applications of the invention will be apparent from the dependent claims and the following description based on the figures. In the drawings:

FIG. 1 is a schematic illustration of a roll seam welding device and of the procedure according to the prior art; and

FIG. 2 is an illustration, which likewise is a schematic illustration, of the procedure according to the invention and of the roll seam welding device according to the invention.

### DESCRIPTION OF THE PREFERRED EMBODIMENTS

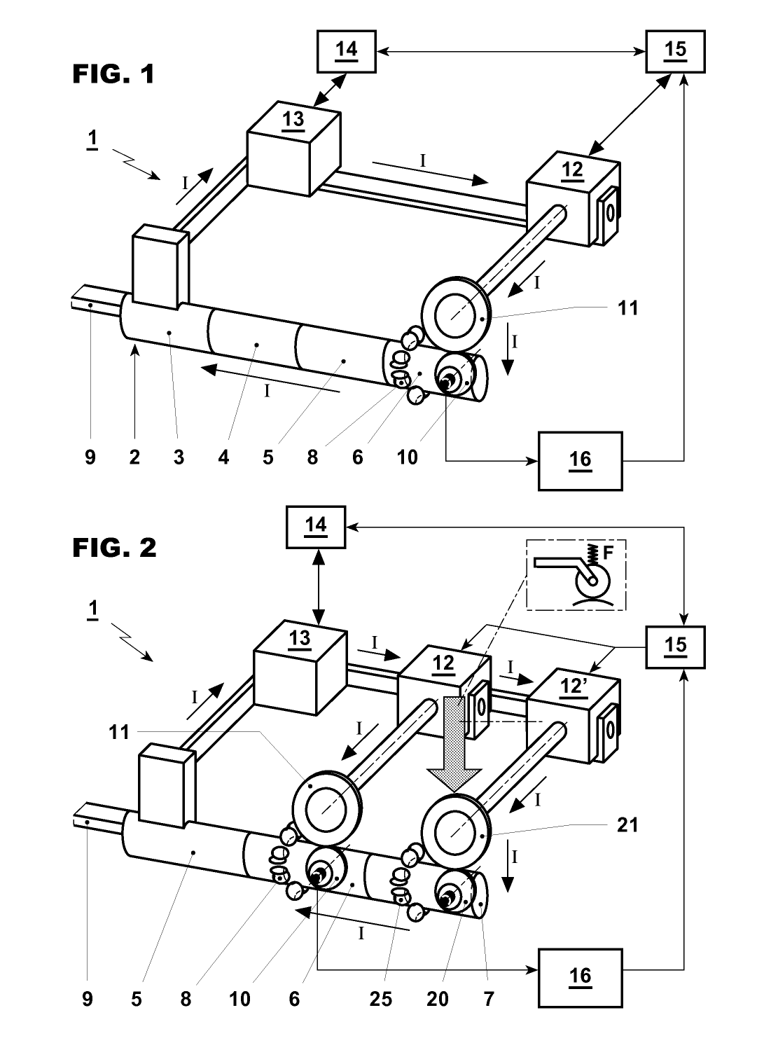

FIG. 1 shows the procedure when welding container bodies, in particular cans, according to the related art. The welding device 1 comprises weld rolls 10 and 11. The lower weld roll 10, which is surrounded by the respective body, but is shown to be visible in the drawing so as if the body were transparent to provide a better explanation, is mounted on a lower arm (not shown) of the welding machine. The upper weld roll 11 is drivingly rotatably mounted, and the force with which it is pressed onto the lower weld roll can be manually set so as to be able to adjust the welding force. The drive and the welding force adjustment by way of an appropriate system are illustrated by the box 12. The sequence 2 of container body blanks or frames 3 to 6, respectively, which were formed by a rounding machine (not shown), is transported along a so-called Z-rail 9 of the welding machine in the direction of the weld rolls 10 and 11. The can body blanks of the sequence 2 are transported along the Z-rail 9 at short distances from each other, wherein the transport arrangement—apart from the Z-rail 9—is not shown here because it is known to a person skilled in the art. A calibration tool 8, which is illustrated only schematically, is generally provided in front of the weld rolls 10, 11. The Z-rail 9, which brings the longitudinal edges of the container bodies, that are to be welded, together into an overlapping position, and the calibration tool 8 prepare the container body blanks for the welding operation so that the edge position for welding is correct and is preserved during the welding process. The longitudinal seam of the container body 6 is welded in FIG. 1, and this body subsequently leaves the welding machine as a container body, which is further processed to form a finished container using steps known to a person skilled in the art. The bodies 3, 4 and 5 are still blanks having unwelded edges.

Instead of overlap-welding overlapping edges, it would also be possible to butt-weld mutually adjoining edges, wherein the Z-rail would then be replaced by a so-called S-rail.

The lower weld roll 10 can generally be rotated about a rigidly mounted rotational axis, and the upper weld roll 11 is mounted in a spring-loaded and drivingly rotatable manner and allows the welding force to be set by way of the described drive unit and welding force adjustment unit 12, which is connected to the control unit 15 of the welding machine. The welding current I provided by a welding current source 14 with a welding transformer 13 is conducted via conductor rails to the upper weld roll 11, flows over the edges of the body blank to be welded to the lower weld roll 10, and is conducted via the lower arm (not shown) of the welding machine and additional conductor rails back to the welding current transformer 13. The aforementioned control unit 15 is provided for controlling the welding machine. A so-called welding monitor 16, which can be part of the control unit 15, can detect data of the welding operation and deliver it to the control unit 15. All of this is known.

FIG. 2 shows the procedure according to the present invention in a similar schematic illustration as in FIG. 1. Identical reference numerals as in FIG. 1 are used for identical or functionally equivalent elements. Again, the weld rolls 10 and 11 are provided, which weld the can body blank 6. One can body that has already been welded by the weld rolls 10, 11 has already left these weld rolls. According to the invention, a second welding operation working on the previously welded container body follows, which here is the welding operation of the previously welded can body 7. The weld rolls 20 and 21 are provided for this purpose. The second welding operation is carried out using a welding force that is derived from a welding parameter of the first welding operation.

In the exemplary embodiment shown, the weld rolls 20 and 21 are arranged directly following the first weld rolls 10 and 11. In the same welding machine, a body 7 that is welded between the first weld rolls 10, 11 thus directly subsequent to the first weld rolls 10, 11 enters between the second weld rolls 20 and 21 without leaving the welding machine. For this purpose transport means 25, similar or identical to calibration tools, engaging on the outside of the body may be provided, which convey the can bodies to the second welding operation after the first welding operation. This may not be necessary if the second weld rolls are arranged so close to the first weld rolls that the can body welded by the first weld rolls 10, 11, upon leaving these rolls, already enters between the second weld rolls 20, 21, so that the can body is picked up by these weld rolls for further transport. In this case, the distance between the two weld roll pairs is smaller than the height of a container body.

As an alternative, a second welding machine can directly follow the first welding machine comprising the first weld rolls, the second welding machine comprising the second weld rolls and being appropriately operated by the control unit, so that the second welding operation is carried out as a function of the at least one parameter.

The second upper weld roll 21 is rotatably driven and the pressing force thereof against the second lower weld roll 20 can be set by way of the control unit 15. This is shown by the unit 12′, which in principle has the same design as the known welding force adjustment unit 12. For symbolizing that the unit 12′ is provided to set the welding force a grey arrow is shown in FIG. 2 in the weld force direction and connected to the unit 12′. Further, a drawing box belongs to this arrow showing in schematic form the upper welding roll acted upon by a spring with a force F. This schematic representation shall give a better understanding. The second lower weld roll 20 is likewise rotatably attached to the lower arm (not shown) of the welding machine. This roll is shown visibly in the drawing, even though it is surrounded by the body and therefore not visible. The welding monitor 16 determines at least one parameter for the weld quality during the first welding operation using the weld rolls 10, 11. This parameter is used to derive the welding force adjustment for the second welding operation by way of the weld rolls 20 and 21. An example of this is described hereafter:

The first welding operation is carried out in one example with a welding force of 50 daN and a welding current of 4500 A for a container body made of DR8 material. The seam temperature is detected as a parameter by the control unit or the monitor. This can be detected for example by a temperature measurement effected at a small distance from the weld rolls and this is known as a measurement already provided by known weld monitors. The energy value of the voltage drop between the welding electrodes and the current in the welding circuit can be detected as a second parameter. One of these parameters, or both parameters, are used to set the welding force of the second welding operation. This can likewise be done manually in that a display indicates the welding force to be set, or the welding force of the second weld rolls can be set automatically by an adjusting device, for example by way of electric motor, pneumatically or magnetically.

The welding force of the second weld operation can be set in dependency from one or both welding parameters of the first welding operation as being equal to the force of the first welding operation or as being greater than the force of the first welding operation or as being lower than the force of the first welding operation, respectively. So, in the example given above, the welding force for the second weld operation can be set lower than 50 daN and can preferably set to a value around 25 daN or to a value around 45 daN. Or the welding force will as well be set to 50 daN for the second welding operation. Or the welding force will be set higher than 50 daN, for example within a range of 55 daN to 70 daN. This can be done with a manual setting of the second welding force and as well with the automatic setting of the second welding force. The selection, whether the second welding operation shall be done with a lower or higher or with the same welding force to attain an optimum weld result after the second welding operation can be made by test weldings on a number of test can bodies for which the weld quality is checked after the second welding. The weld quality checking is done in a known manner on the one hand by a visual control of the weld seam and on the other hand by tearing apart of the weld seam. With the mentioned test can bodies it is evaluated for different values of the welding parameter (weld seam temperature and/or energy value from the voltage drop between the first weld electrodes and the welding current) if a lower or higher or equal value for the welding force of the second welding of the test can bodies results in a better quality of the weld. When a value for the welding force has been found, this value can be used for a series of can bodies. Even during welding of a series of can bodies such an evaluation can be made after an arbitrary time or at periodic times. Of course, welding parameters and weld force values can be stored in tables and can be recalled when welding the same or similar metal sheet material, so that a new evaluation of the value for the second welding force in dependency from the welding parameter can be avoided since the values evaluated earlier can be used again. Of particular advantage is the use of the present invention when container bodies are welded which are made from Electrolytically Chromium Coated Steel (ECCS).

While the present application describes preferred embodiments of the invention, it shall be pointed out that the invention is not limited to these and can also be implemented in another manner within the scope of the following claims.

1. A method for roll seam welding the overlapping or abutting edges of a sequence (2) of container body blanks (3 to 7), whereby a sequence of container bodies is formed, wherein at least one welding parameter that is relevant for the weld quality is detected and evaluated during the welding operation of a container body blank,
characterized in that
on at least one container body (7) of the sequence of container bodies, the previously generated weld seam is subjected to a second welding operation,
wherein the welding force of the second welding operation is set as a function of the at least one detected welding parameter.

2. The method according to claim 1, characterized in that the second welding operation is carried out in the same welding machine, subsequent to the first welding operation.

3. The method according to claim 2, characterized in that the container body welded by the first weld rolls is picked up by the second weld rolls (20, 21) upon exiting the first weld rolls (10, 11).

4. The method according to claim 2, characterized in that the container body welded by the first weld rolls is picked up by a transport means (25) and is transported by the same to the second weld rolls.

5. A method according to claim 1, characterized in that the weld seam temperature is detected as a parameter.

6. A method according to claim 1, characterized in that the energy value of the voltage drop between the first welding electrodes and the welding current is detected as a parameter.

7. A method according to claim 1, characterized in that two parameters are detected, wherein the weld seam temperature is detected as a first parameter, and the energy value of the voltage drop between the first welding electrodes and the welding current is detected as a second parameter, and wherein the welding force of the second welding electrodes is set as a function of the two parameters.

8. A method according to claim 1, characterized in that Electrolytically Chromium Coated Steel (ECCS) is welded.

9. A method according to claim 1 characterized in that depending on the detected parameter the welding force of the second welding is set to be lower as during the first welding or is set to be equal as during the first welding or is set to be greater than during the first welding, respectively.

10. A method according to claim 1 characterized in that the setting of the second weld force in dependency of the detected weld parameter is evaluated by a series of test can bodies which are welded with first and second welding operation and which are afterwards examined visually and mechanically for weld seam quality.

11. A roll seam welding device (1), comprising weld rolls (10, 11), a transport unit (9) and a calibration unit (8) for feeding container body blanks (3 to 7) having overlapping or abutting edges to the weld rolls of the device, and comprising a control unit (15, 16), which is designed to detect and evaluate at least one welding parameter that is relevant for the quality of the generated weld seam during the welding operation of a container body, characterized in that the welding device comprises a second set of weld rolls (20, 21), which follows on the first weld rolls in the direction of the container body transport, and the control unit (15, 16) is designed to set the welding force of the second set of weld rolls for a container body as a function of the detected welding parameter.

12. The roll seam welding device according to claim 11, characterized by being designed in such a way that the container body welded by the first weld rolls is picked up by the second weld rolls (20, 21) upon exiting the first weld rolls (10, 11).

13. The roll seam welding device according to claim 11, characterized by comprising a transport device (25), which is designed to pick up the container body welded by the first weld rolls and transport the same to the second weld rolls.

14. A roll seam welding device according to claim 11, characterized by being designed to detect the weld seam temperature as the parameter.

15. A roll seam welding device according to claim 11, characterized by being designed to detect the energy value of the voltage drop between the first welding electrodes and the welding current as the parameter.

16. A roll seam welding device according to claim 11, characterized by being designed to detect two parameters, wherein the weld seam temperature can be detected as a first parameter, and the energy value of the voltage drop between the first welding electrodes and the welding current can be detected as a second parameter, and wherein the roll seam welding device can set the welding force of the second welding electrodes as a function of the two parameters.

17. A method according to claim 2, characterized in that the weld seam temperature is detected as a parameter.

18. A method according to claim 3, characterized in that the weld seam temperature is detected as a parameter.

19. A method according to claim 4, characterized in that the weld seam temperature is detected as a parameter.

20. A method according to claim 2, characterized in that the energy value of the voltage drop between the first welding electrodes and the welding current is detected as a parameter.
